(19) United States
(12) Patent Application Publication
(10) Pub. No.: US 2015/0338434 A1
(43) Pub. Date: Nov. 26, 2015

(54) POSITION DETECTION APPARATUS OF MICRO-ELECTROMECHANICAL SYSTEM AND DETECTION METHOD THEREOF

(71) Applicant: Lite-On Technology Corporation, Taipei City (TW)

(72) Inventors: Wen-Lung Lin, Taipei City (TW); De-Jian Ou, Taipei City (TW)

(21) Appl. No.: 14/596,230

(22) Filed: Jan. 14, 2015

(30) Foreign Application Priority Data
May 23, 2014 (CN) 201410222433.1

(51) Int. Cl. G01P 15/125; G01D 5/24

(52) U.S. Cl. CPC G01P 15/125; G01D 5/24

(57) ABSTRACT

A position detection apparatus for detecting position information of a micro-electromechanical system apparatus includes an oscillating circuit, a carrier frequency detector, and a demodulator. The oscillating circuit generates an oscillating signal according to an equivalent capacitance provided by the micro-electromechanical system apparatus. The carrier frequency detector detects the oscillating signal to obtain a carrier frequency information of the oscillating signal. The demodulator demodulates the oscillating signal according to the carrier frequency information and thus obtains position information of the micro-electromechanical system apparatus.

### CROSS-REFERENCE TO RELATED APPLICATION

This application claims the priority benefit of China application serial no. 201410222433.1, filed on May 13, 2014. The entirety of the above-mentioned patent application is hereby incorporated by reference herein and made a part of this specification.

### BACKGROUND OF THE INVENTION

1. Field of the Invention

The invention relates to a position detection apparatus, and particularly relates to a detection apparatus for detecting position information of a micro-electromechanical system and a detection method thereof.

2. Description of Related Art

Recently, the applications of capacitance detection in the field of micro-electromechanical system (MEMS) have become more broad and common. Due to the characteristics of being small-sized, miniaturized in proportion, and portable, the internal elements of the MEMS have a higher sensitivity to the environmental variables such as temperature and noises, making it difficult to obtain the position information of the MEMS. However, the position information of the MEMS may be obtained in a more precise manner by using the technology such as capacitance detection.

However, in the conventional technology, the common method is to detect capacitance by using a phase lock loop (PLL) or by detecting micro-currents. Such common method is easily influenced by the factors such as temperature, noises, and differences between elements (such as inductor, resistor, and capacitors), rendering the outcome of detection imprecise. Therefore, it is still necessary to find out a technique to detect the position information of the MEMS in a more precise manner.

### SUMMARY OF THE INVENTION

The invention provides a position detection apparatus and a detection method thereof for detecting position information of a micro-electromechanical system.

The position detection apparatus according to embodiments of the invention includes an oscillating circuit, a carrier frequency detector, and a demodulator and is applicable for detecting a position of the micro-electromechanical system. The oscillating circuit is coupled to the micro-electromechanical system and generates an oscillating signal according to an equivalent capacitance provided by the micro-electromechanical system. The carrier frequency detector is coupled to the oscillating circuit and detects the oscillating signal to obtain carrier frequency information of the oscillating signal. The demodulator is coupled to the oscillating circuit and the carrier frequency detector, and demodulates the oscillating signal according to the carrier frequency information to obtain the position information of the micro-electromechanical system.

The method for detecting position information of a micro-electromechanical system according to embodiments of the invention includes: generating an oscillating signal according to an equivalent capacitance provided by the micro-electromechanical system to be detected; detecting the oscillating signal to obtain carrier frequency information of the oscillating signal; and demodulating the oscillating signal according to the detected carrier frequency information to obtain the position information of the micro-electromechanical system.

Based on the above, the method provided in the invention realizes capacitance detection by using demodulation, and the method provided in the invention is not influenced by temperature, noises, and differences between elements (e.g. inductor, resistor, and capacitor). Therefore, the method is capable of detecting the position information of the micro-electromechanical system more precisely.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a position detection apparatus according to an embodiment of the invention.

FIG. 2 is a schematic diagram illustrating an embodiment of the oscillating circuit of FIG. 1 according to an embodiment of the invention.

FIG. 3 is a schematic diagram illustrating an embodiment of the demodulator of FIG. 1 according to an embodiment of the invention.

FIG. 4 is a block diagram of a position detection apparatus according to another embodiment of the invention.

FIG. 5 is a schematic diagram illustrating an embodiment of the analogical low-pass filter of FIG. 4 according to another embodiment of the invention.

FIG. 6 is a flow chart of a method for detecting position information of a micro-electromechanical system according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The position detection apparatus described herein may be applied in a micro-electromechanical system, such as a pico-projector, a miniaturized microphone, a hearing aid, or other portable micro-electromechanical systems. However, the invention is not limited thereto.

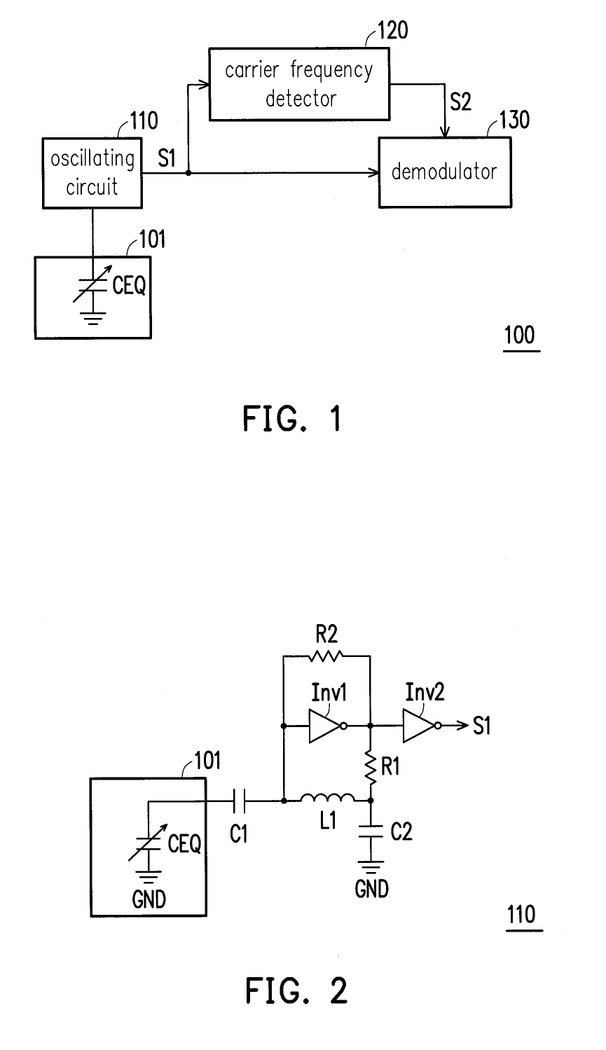

FIG. 1 is a schematic diagram of a detection apparatus according to an embodiment of the invention. Referring to FIG. 1, a position detection apparatus 100 includes an oscillating circuit 110, a carrier frequency detector 120, and a demodulator 130. The position detection apparatus 100 is configured to detect position information of a micro-electromechanical system 101. The micro-electromechanical system 101 provides an equivalent capacitance CEQ. In addition, a capacitance value of the equivalent capacitance CEQ changes as the position information of the micro-electromechanical system 101 changes. Taking the micro-electromechanical system 101 utilized in a pico-projector for example, the micro-electromechanical system 101 may drive an optical element in the pico-projector, so as to change a projected image beam position and perform image scanning accordingly. When the micro-electromechanical system 101 drives the optical element in the pico-projector, the change of position information correspondingly changes the capacitance value of the equivalent capacitance CEQ provided by the micro-electromechanical system 101.

The oscillating circuit 110 is coupled to the micro-electromechanical system 101 and generates an oscillating signal S1 according to the capacitance value of the equivalent capacitance CEQ provided by the micro-electromechanical system 101. Here, a carrier frequency of the oscillating signal S1 may be determined by the capacitance value of the equivalent capacitance CEQ. In addition, given that the position information of the micro-electromechanical system 101 changes periodically, the carrier frequency of the oscillating signal S1 also changes periodically in correspondence with the position information of the micro-electromechanical system 101. Specifically, the change of the carrier frequency of the oscillating signal S1 may be represented as ωc±df. In the representation above, ωc represents a main frequency of the oscillating signal S1, while df represents a frequency drift that possibly occurs.

The carrier frequency detector 120 is coupled to an output end of the oscillating circuit 110 and detects the oscillating signal S1 generated by the oscillating circuit 110, so as to obtain carrier frequency information S2 associated with the oscillating signal S1. The carrier frequency information S2 obtained by the carrier frequency detector 120 may be provided to the demodulator 130 to demodulate the oscillating signal S1 to obtain the position information of the micro-electromechanical system 101. In an embodiment of the invention, the carrier frequency detector 120 samples the oscillating signal S1 for a period of time by using a sampling clock signal, so as to obtain a plurality of sampling outcomes. Then, an average of the plurality of sampling outcomes is calculated to further obtain the carrier frequency information S2. More specifically, the carrier frequency detector 120 uses the sampling clock signal to sample a plurality of cycles of the oscillating signal S1, and after sampling for a period of time, a plurality of cycle outcomes of the oscillating signal S1 may be obtained. Given that changes in durations of cycles of the oscillating signal S1 are periodical, the carrier frequency detector 120 may calculate the average of the plurality of cycle outcomes to obtain the carrier frequency information S2. In addition, the carrier frequency information S2 is an outcome of detection of the main frequency ωc of the oscillating signal S1. However, due to factors such as changes in temperature of the environment, influences of the temperature coefficient of an inductor or a capacitor, or errors of the inductor or capacitor itself, the main frequency ωc of the oscillating signal S1 may change dynamically, but the carrier frequency detector 120 is capable of detecting the main frequency ωc of the oscillating signal S1 in real time and provides the main frequency ωc of the oscillating signal S1 to the demodulator 130.

The demodulator 130 is coupled to the oscillating circuit 110 and the carrier frequency detector 120. In addition, an input end coupled to the oscillating circuit 110 receives the oscillating signal S1 generated by the oscillating circuit 110, while an output end coupled to the carrier frequency detector 120 receives the carrier frequency information S2 obtained by the carrier frequency detector 120. In addition, the demodulator 130 may use the carrier frequency information S2 to demodulate the oscillating signal S1, and further obtain the position information of the micro-electromechanical system 101. In an embodiment of the invention, the demodulator 130 may be a digital demodulator that performs digital demodulation to demodulate and obtain frequency information about the oscillating signal S1. Then the position information of the micro-electromechanical system 101 is obtained through an arithmetic operation. Specifically speaking, digital demodulation includes demodulation techniques such as amplitude shift keying (ASK), frequency shift keying (FSK), phase shift keying (PSK) or quadrature phase shift keying (QPSK), etc. The techniques may be used to obtain the position information of the micro-electromechanical system 101.

FIG. 2 illustrates an embodiment of the oscillating circuit 110 of FIG. 1 of the invention. Referring to FIG. 2, the oscillating circuit 110 may be an inductor-capacitor oscillator that includes an inductor L1, capacitors C1 and C2, inverters Inv1 and Inv2, and resistors R1 and R2. In this embodiment, the micro-electromechanical system 101 provides the equivalent capacitance CEQ, and the equivalent capacitance CEQ is serially connected between an input end of the oscillating circuit 110 and a reference ground terminal GND. In addition, the capacitance value of the equivalent capacitance CEQ may be varied according to a variation of the position information of the micro-electromechanical system 101.

In FIG. 2, a first end of the capacitor C1 is coupled to a first end of the equivalent capacitance CEQ, and a second end of the capacitor C1 is coupled to a first end of the inductor L1. A second end of the inductor L1 is coupled to a first end of the capacitor C2. A second end of the capacitor C2 is coupled to the reference ground terminal GND. An input end of the inverter Inv1 is coupled to the second end of the capacitor C1, and an output end of the inverter Inv1 is coupled to an input end of the inverter Inv2. The resistor R1 is serially connected between the first end of the capacitor C2 and the output end of the inverter Inv1. The resistor R2 is serially connected between the output end and input end of the inverter Inv1. The input end of the inverter Inv2 is coupled to the output end of the inverter Inv1, and the oscillating signal S1 is generated at an output end of the inverter Inv2.

The oscillating circuit 110 may determine an oscillating frequency of the oscillating signal S1 according to an inductance value of the inductor L1, capacitance values of the capacitors C1 and C2, and the capacitance value of the equivalent capacitance CEQ. Also, the frequency of the oscillating signal S1 may be changed periodically as the equivalent capacitance CEQ is changed in correspondence with the changing of the position information of the micro-electromechanical system 101.

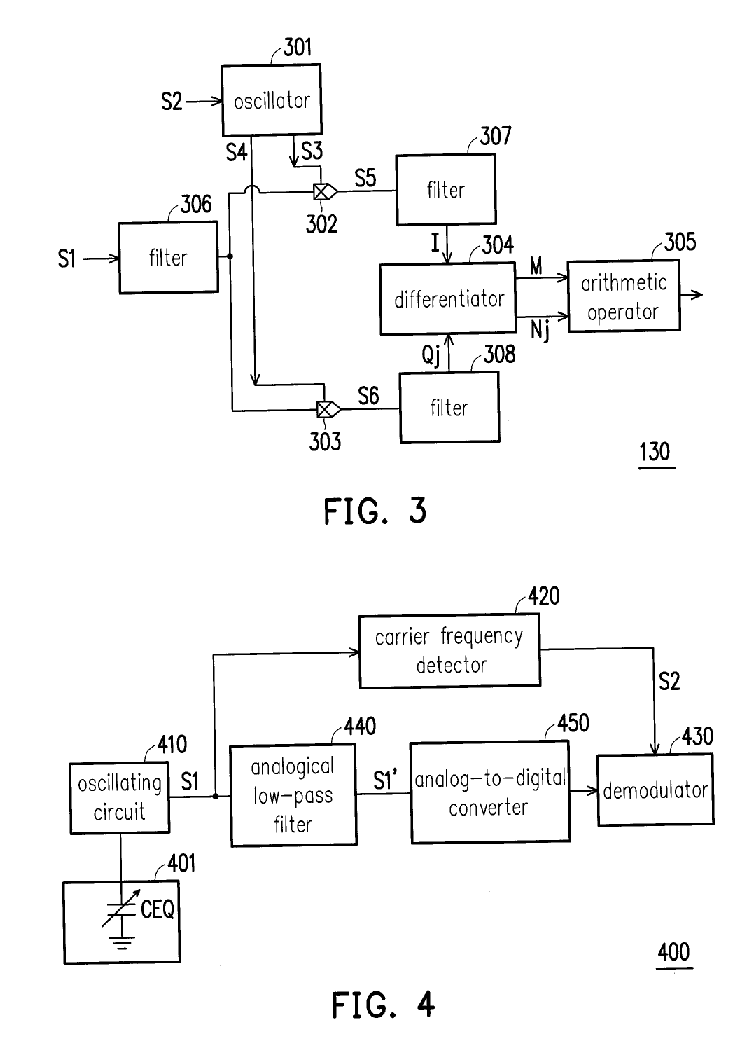

FIG. 3 illustrates an embodiment of the demodulator 130 of FIG. 1 of the invention. Referring to FIG. 3, the demodulator 130 includes an oscillator 301, mixers 302 and 303, a differentiator 304, an arithmetic operator 305, and filters 306, 307, and 308. The demodulator 130 receives the oscillating signal S1 generated by the oscillating circuit and the carrier frequency information S2 detected by the carrier frequency detector 120, and uses the carrier frequency information S2 to demodulate the oscillating signal S1.

The oscillator 301 receives the carrier frequency information S2 detected by the carrier frequency detector 120 and generates a reference oscillating signal S3 and a reference oscillating signal S4 according to the carrier frequency information S2. In addition, the reference oscillating signal S3 and the reference oscillating signal S4 are orthogonal signals with respect to each other and are respectively provided to the mixers 302 and 303. For example, the reference oscillating signal S3 may be a sine wave sin(ωt+Φ), while the reference oscillating signal S4 may be a cosine wave cos(ωt+Φ). In addition, the frequency ωt is the main frequencies of the reference oscillating signals S3 and S4 and may be determined by the carrier frequency information S2. Moreover, the carrier frequency information S2 may be the main frequency ωc of the oscillating signal S1.

The filter 306 is coupled on a path that the mixers 302 and 303 receive the oscillating signal S1 generated by the oscillating circuit 110 and filters the oscillating signal S1. Therefore, the mixer 302 receives the filtered oscillating signal S1 and the reference oscillating signal S3 generated by the oscillator 301 and mixes the two signals, so as to generate a mixed signal S5. The mixer 303 receives the filtered oscillating signal S1 and the reference oscillating signal S4 generated by the oscillator 301 and mixes the two signals, so as to generate a mixed signal S6.

The filter 307 is coupled on a path that the differentiator 304 receives the mixed signal S5, so as to filter the mixed signal S5 and generate a signal I. The filter 308 is coupled on a path that the differentiator 304 receives the mixed signal S6, so as to filter the mixed signal S6 and generate a signal Qj. Then, the signals I and Qj are used to re-build the carrier frequency information of the oscillating signal S1. The differentiator 304 receives and respectively differentiates the signals I and Qj, so as to generate differentiated signals M and Nj, thereby obtaining the position information of the micro-electromechanical system 101 by using the arithmetic operator 305.

In an embodiment of the invention, the filters 306, 307, and 308 are low-pass filters. The filter 306 filters out noise in the oscillating signal S1 generated by the oscillating circuit 110. The filter 307 receives the mixed signal S5 and filters out a high-frequency harmonic component due to mixing of the mixer 302, and the filter 308 receives the mixed signal S6 and filters out a high-frequency harmonic component due to mixing of the mixer 303.

The arithmetic operator 305 receives the differentiated signals M and Nj generated by the differentiator 304 and performs an arithmetic operation to obtain the position information of the micro-electromechanical system 101. In an embodiment of the invention, the arithmetic operator 305 performs an arctangent functional operation to the differentiated signals M and Nj and uses an outcome of the operation, such as arctan (N/M), to obtain the position information of the micro-electromechanical system 101.

FIG. 4 is a schematic diagram of a position detection apparatus that detects a position of a micro-electromechanical system according to another embodiment of the invention. Referring to FIG. 4, a position detection apparatus 400 includes an oscillating circuit 410, a carrier frequency detector 420, a demodulator 430, an analog low-pass filter 440, and an analog-to-digital converter 450. The position detection apparatus 400 is configured to detect position information of the micro-electromechanical system 401. The micro-electromechanical system 401 may provide the equivalent capacitance CEQ, and the capacitance value of the equivalent capacitance CEQ changes as the position information of the micro-electromechanical system 401 changes. As effects and embodiments of the oscillating circuit 410, the carrier frequency detector 420, and the demodulator 430 are the same as those in the embodiment shown in FIG. 1, no further details in this respect will be reiterated below. Besides, the analog low-pass filter 440 is added to the position detection apparatus 400 to eliminate signal distortion caused by noises due to external environmental factors. The analog low-pass filter 440 makes a signal at a specific carrier frequency salient and attenuates signals at other frequencies, thereby eliminating the noise. The analog-to-digital converter 450 receives a filtered analogical oscillating signal S1′, converts the filtered analogical oscillating signal S1′ into a digital format, and provides the converted signal to the demodulator 430 to be demodulated, so as to obtain the position information of the micro-electromechanical system 401.

It should also be noted that the analog low-pass filter 440 may be an active filter circuit having a cut-off frequency to filter out a signal component in the oscillating signal S1 higher than the cut-off frequency, so as to filter out the noise. In another embodiment of the invention, the oscillating signal S1 may be a square wave whose carrier frequency is ωc. After being filtered analogically, a sine wave, as the analogical oscillating signal S1′, having the main frequency as ωc and having fewer noises may be obtained.

An input end of the analog-to-digital converter 450 is coupled to the low-pass filter 440 to receive the analogical oscillating signal S1′ and convert the analogical oscillating signal S1′ into a digital format to be provided to and demodulated by the demodulator 430 coupled at an output end of the analog-to-digital converter 450, thereby obtaining the position information of the micro-electromechanical system 401. In another embodiment of the invention, the analog-to-digital converter 450 may convert the input analogical oscillating signal S1′ into a digital format, such as converting a sine wave into a square wave.

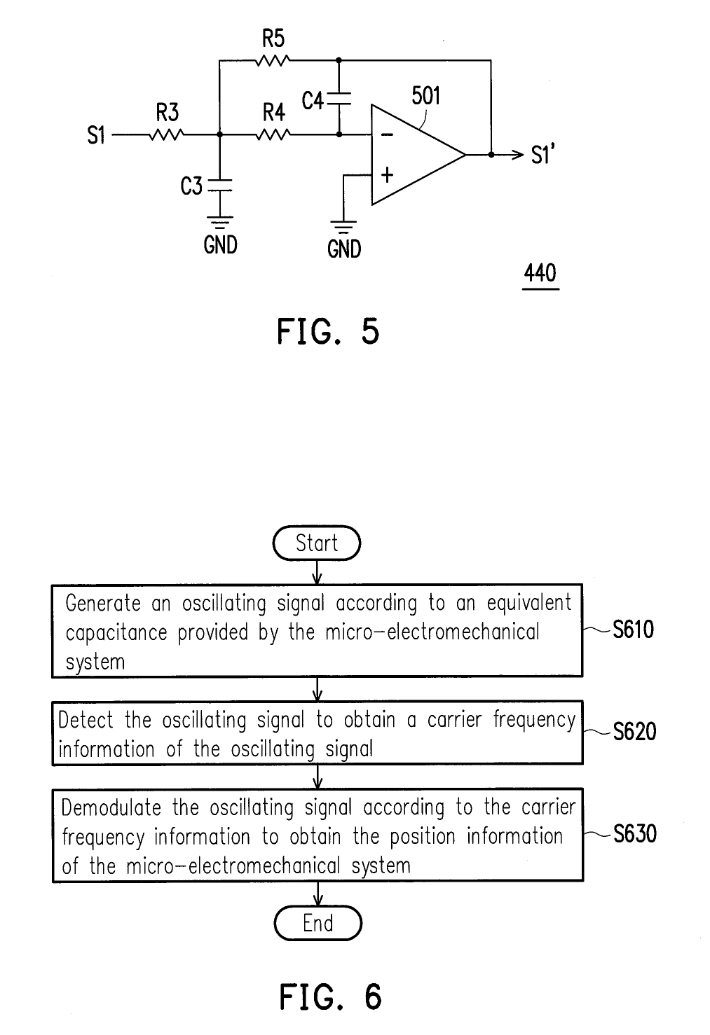

FIG. 5 illustrates an embodiment of the analogical low-pass filter 440 of FIG. 4 of the invention. Referring to FIG. 5, the analogical low-pass filter 440 includes resistors R3, R4, and R5, capacitors C3 and C4, and an operational amplifier 501.

In FIG. 5, a first end of the resistor R3 receives the oscillating signal S1, a first end of the resistor R4 is coupled to a second end of the resistor R3, and a first end of the resistor R5 is coupled to the second end of the resistor R3. A first end of the capacitor C3 is coupled to the second end of the resistor R3, and a second end of the capacitor C3 is coupled to the reference ground terminal GND. The capacitor R4 is coupled between a second end of the resistor R4 and a second end of the resistor R5. A first input end of the operational amplifier 501 is coupled to the second end of the resistor R4, and a second end of the operational amplifier 501 is coupled to the reference ground terminal GND. An output end of the operational amplifier 501 is coupled to the second end of the resistor R5 and generates the analogical oscillating signal S1′. The analogical oscillating signal S1′ may be input to the analog-to-digital converter 450 to be converted into a digital format, so as to be demodulated by the demodulator 430 to obtain the position information of the micro-electromechanical system 401.

In addition, using the operational amplifier 501 in the analogical low-pass filter 440 with passive elements such as the resistors R3, R4, and R5 and the capacitors C3 and C4 may determine the cut-off frequency of the analogical low-pass filter 440 and a gain of the operational amplifier 501.

FIG. 6 is a flow chart of a method for detecting position information of a micro-electromechanical system according to an embodiment of the invention. Referring to FIG. 6, the detection method includes steps as follows. First of all, an oscillating signal is generated according to an equivalent capacitance provided by the micro-electromechanical system (S610). Then, the oscillating signal is detected to obtain carrier frequency information of the oscillating signal (S620). Afterwards, the oscillating signal is demodulated according to the carrier frequency information, so as to obtain the position information of the micro-electromechanical system (S630).

Details with respect to how each of the above steps is embodied are described in details in the embodiments above. Therefore, no further details in this respect will be reiterated below.

In view of the foregoing, the invention uses demodulation for capacitance detection, so as to obtain the position information of the micro-electromechanical system. Therefore, the position detection of the micro-electromechanical system is not influenced by temperature, noises, and differences between elements (e.g. inductor, resistor, and capacitor), and the more precise position information of the micro-electromechanical system may be detected. In addition, jitters generated when the position of the micro-electromechanical system changes are reduced due to the improved detection accuracy.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A position detection apparatus adapted for detecting position information of a micro-electromechanical system, comprising:
an oscillating circuit, coupled to the micro-electromechanical system and generating an oscillating signal according to an equivalent capacitance provided by the micro-electromechanical system;
a carrier frequency detector, coupled to the oscillating circuit and detecting the oscillating signal to obtain carrier frequency information of the oscillating signal; and
a demodulator, coupled to the oscillating circuit and the carrier frequency detector, demodulating the oscillating signal according to the carrier frequency information to obtain the position information of the micro-electromechanical system.

2. The position detection apparatus as claimed in claim 1, wherein the equivalent capacitance is varied according to a variation of the position information of the micro-electromechanical system.

3. The position detection apparatus as claimed in claim 1, wherein the oscillating circuit is an inductor-capacitor oscillator, the oscillating circuit comprises an inductor, and an oscillating frequency of the oscillating signal is determined according to an inductance value of the inductor and the equivalent capacitance.

4. The position detection apparatus as claimed in claim 3, wherein the oscillating circuit further comprises:
a first capacitor, wherein one end of the first capacitor is coupled to a first end of the equivalent capacitance, and a second end of the first capacitor is coupled to a first end of the inductor;
a first inverter, wherein an input end of the first inverter is coupled to the second end of the first capacitor;
a second inverter, wherein an input end of the second inverter is coupled to an output end of the first inverter, and an output end of the second inverter generates the oscillating signal;
a second capacitor, wherein a first end of the second capacitor is coupled to a second end of the inductor, and a second end of the second capacitor is coupled to a reference ground terminal;
a first resistor, serially connected between the first end of the second capacitor and the output end of the first inverter; and
a second resistor, serially connected between the input end and the output end of the first inverter, wherein
a second end of the equivalent capacitance is coupled to the reference ground terminal.

5. The position detection apparatus as claimed in claim 1, wherein the demodulator comprises:
an oscillator, receiving the carrier frequency information and generating a first reference oscillating signal and a second reference oscillating signal orthogonal with respect to each other according to the carrier frequency information;
a first mixer, receiving the oscillating signal and the first reference oscillating signal and generating a first mixed signal by mixing the oscillating signal and the first reference oscillating signal;
a second mixer, receiving the oscillating signal and the second reference oscillating signal and generating a second mixed signal by mixing the oscillating signal and the second reference oscillating signal;
a differentiator, receiving and differentiating the first mixed signal and the second mixed signal, so as to respectively generate a first differentiated mixed signal and a second differentiated mixed signal; and
an arithmetic operator, receiving the first differentiated mixed signal and the second differentiated mixed signal and performing an arithmetic operation to the first differentiated mixed signal and the second differentiated mixed signal, so as to obtain the position information of the micro-electromechanical system.

6. The position detection apparatus as claimed in claim 5, wherein the demodulator further comprises:
a first filter, coupled on a path that the first mixer and the second mixer receive the oscillating signal to filter the oscillating signal;
a second filter, coupled on a path that the differentiator receives the first mixed signal to filter the first mixed signal; and
a third filter, coupled on a path that the differentiator receives the second mixed signal to filter the second mixed signal.

7. The position detection apparatus as claimed in claim 1, wherein the carrier frequency detector obtains the carrier frequency information by calculating a cycle average of a plurality of cycles of the oscillating signal.

8. The position detection apparatus as claimed in claim 7, wherein the carrier frequency detector uses a sampling clock signal to sample the cycles of the oscillating signal to obtain a plurality of sampling outcomes, and the carrier frequency detector calculates an average of the sampling outcomes to obtain the carrier frequency information.

9. The position detection apparatus as claimed in claim 1, further comprising:
an analogical low-pass filter, coupled to the oscillating circuit to receive the oscillating signal and generating a filtered analogical oscillating signal by analogically filtering the oscillating signal; and
an analog-to-digital converter, coupled to the analogical low-pass filter to receive the filtered analogical oscillating signal and convert the filtered analogical oscillating signal into a digital format,
wherein the filtered analogical oscillating signal is provided to the demodulator for demodulation, so as to obtain the position information of the micro-electromechanical system.

10. The position detection apparatus as claimed in claim 9, wherein the analogical low-pass filter comprises:
a first resistor, wherein a first end of the first resistor receives the oscillating signal;
a second resistor, wherein a first end of the second resistor is coupled to a second end of the first resistor;
a third resistor, wherein a first end of the third resistor is coupled to the second end of the first resistor;
a first capacitor, wherein a first end of the first capacitor is coupled to the second end of the first resistor, and a second end of the first capacitor is coupled to the reference ground terminal;
a second capacitor, serially connected between a second end of the second resistor and a second end of the third resistor; and
an operational amplifier, wherein a first input end of the operational amplifier is coupled to the second end of the second resistor, a second end of the operational amplifier is coupled to the reference ground terminal, an output end of the operational amplifier is coupled to the second end of the third resistor, and the output end of the operational amplifier generates the filtered analogical oscillating signal.

11. A method for detecting position information of a micro-electromechanical system, comprising:
generating an oscillating signal according to an equivalent capacitance provided by the micro-electromechanical system;
detecting the oscillating signal to obtain a carrier frequency information of the oscillating signal; and
demodulating the oscillating signal according to the carrier frequency information to obtain the position information of the micro-electromechanical system.

12. The method for detecting the position information of the micro-electromechanical system as claimed in claim 11, wherein the equivalent capacitance is varied according to a variation of the position information of the micro-electromechanical system changes.

13. The method for detecting the position information of the micro-electromechanical system as claimed in claim 11, wherein the step of generating the oscillating signal according to the equivalent capacitance provided by the micro-electromechanical system comprises:
using an inductor-capacitor oscillator to determine an oscillating frequency of the oscillating signal according to an inductance value of the inductor and the equivalent capacitance.

14. The method for detecting the position information of the micro-electromechanical system as claimed in claim 11, wherein the step of detecting the oscillating signal to obtain the carrier frequency information of the oscillating signal comprises:
obtaining the carrier frequency information by calculating a cycle average of a plurality of cycles of the oscillating signal.

15. The method for detecting the position information of the micro-electromechanical system as claimed in claim 14, wherein the step of obtaining the carrier frequency information by calculating the cycle average of the cycles of the oscillating signal comprises:
using a sampling clock signal to sample the cycles of the oscillating signal, so as to obtain a plurality of sampling outcomes; and
calculating an average of the sampling outcomes to obtain the carrier frequency information.

16. The method for detecting the position information of the micro-electromechanical system as claimed in claim 11, further comprising:
generating a filtered analogical oscillating signal by analogically filtering the oscillating signal;
receiving the filtered analogical oscillating signal and converting the filtered analogical oscillating signal into a digital format; and
providing the filtered analogical oscillating signal for demodulation, so as to obtain the position information of the micro-electromechanical system.
